(19) United States
(12) Patent Application Publication
(10) Pub. No.: US 2009/0316945 A1
(43) Pub. Date: Dec. 24, 2009

(54) Transportable Sensor Devices

(76) Inventor: Ali N. Akansu, Middletown, NJ (US)

Correspondence Address: GIBSON & DERNIER L.L.P., 900 ROUTE 9 NORTH, SUITE 504, WOODBRIDGE, NJ, 07095, US

(21) Appl. No.: 12/143,000

(22) Filed: Jun. 20, 2008

(51) Int. Cl. H04R 11/04

(52) U.S. Cl. 381/364

(57) ABSTRACT

A transportable sensor or set of sensors maybe carried conveniently by a user in a condition ready to be connected to a computing device, such as a PDA, a pocket computer, a laptop computer, or a desktop computer which may have an internet connection and communications capabilities. The sensor(s) maybe carried by a user, preferably on his person, in a convenient way and so that they may be readily and quickly connected to a computing device. It is contemplated that such connection would be possible through the inclusion of a modular or industry standard connector on the device. The sensor could also be detachably connectable to or housed within a housing provided in an article with an independent function, such as a pen, a wireless telephone, an eyeglass frame, an eyeglass cover, a shirt pocket, a belt, or an article of clothing worn by a user.

### TECHNICAL FIELD

The present invention relates generally to transportable sensor devices and, more particularly, concerns sensor devices which are easily storable and transported by a user so as to be readily available at any time for use with such devices as PDA's, pocket computers, laptop computers, and desktop computers.

### BACKGROUND OF THE INVENTION

Today, it is common for individuals to carry portable computing devices, such as PDA's, but they are also likely to encounter computing devices, such as laptop computers and desktop computers many times in a course of a day. These computing devices sometimes have their own sensors (e.g.; microphones) and sometimes do not. Moreover, if such a device has a sensor, it may be of a different type from that with which the user is used to working. It would therefore be highly desirable for a user to be able to carry a sensor device with him or on his person, so that it would be ready for use any time he encounters a computing device.

### SUMMARY OF THE INVENTION

In accordance with one aspect of the present invention, a transportable sensor or set of sensors maybe carried conveniently by a user in a condition ready to be connected to a computing device, such as a PDA, a pocket computer, a laptop computer, or a desktop computer which may have an internet connection and communications capabilities. The sensor(s) may be carried by a user, preferably on his person, in a convenient way and so that they may be readily and quickly connected to a computing device. It is contemplated that such connection would be possible through the inclusion of a modular or industry standard connector on the device.

In accordance with another aspect of the invention, a sensor is housed in a housing made of a readily available material, such as plastic or metal, and it is constructed to be detachably connectable to another device, such as a pen, a wireless telephone, an eyeglass frame, an eyeglass cover, a shirt pocket, a belt, or an article of clothing worn by the user. It is also contemplated that a sensor may be removably housed within another article, such as a pen, a wireless telephone, an eyeglass frame, an eyeglass cover, or an article of clothing worn by the user.

In accordance with certain embodiments of the invention, the sensor is a miniature microphone, which is constructed to be detachably secured or housed within a pen or a pencil, or another article carried by a user.

In accordance with certain embodiments of the invention, the sensor is a miniature microphone constructed to be detachably secured to a pocket and/or an article of clothing of the user.

In accordance with certain embodiments of the invention, the sensor is a miniature microphone detachably securable to a belt, eyeglasses, eyeglass cover, a wireless telephone, or personal property which is typically carried by a user.

In accordance with certain embodiments of the invention, an article typically carried by the user, such as pen, a pencil, a belt, eyeglasses, an eyeglass cover, a wireless telephone, a purse, a bag, a briefcase or the like is constructed to have a compartment that houses the sensor, from which it can quickly and easily be removed for your use. In accordance with some such embodiments, the sensor is a miniature microphone which has a built in, industry standard connector, which can readily be inserted into a mating industry standard connector on a computing device.

### BRIEF DESCRIPTION OF THE DRAWINGS

The foregoing brief description and further objects, features, and advantages of the present invention will be understood more completely from the following detailed description of presently preferred, but nonetheless illustrative, embodiments in accordance with the present invention, would reference being had to the accompanying drawings, in which:

FIG. 1 is a perspective view illustrating a portion of a transportable miniature microphone assembly M embodying the present invention;

FIG. 2 is a perspective view illustrating the complete transportable miniature microphone assembly M of FIG. 1;

FIGS. 3 and 4 are schematic diagrams illustrating the internal construction of alternative versions of sensor S of FIG. 1;

FIG. 5 is a perspective view of a further embodiment M′ of a transportable sensor in accordance with the present invention;

FIG. 6 is a perspective view of another embodiment M″ of a sensor embodying the present invention; and

FIGS. 7 and 8 are perspective views of yet another embodiment P of a transportable sensor embodying the present invention.

### DETAILED DESCRIPTION OF THE PREFERRED EMBODIMENTS

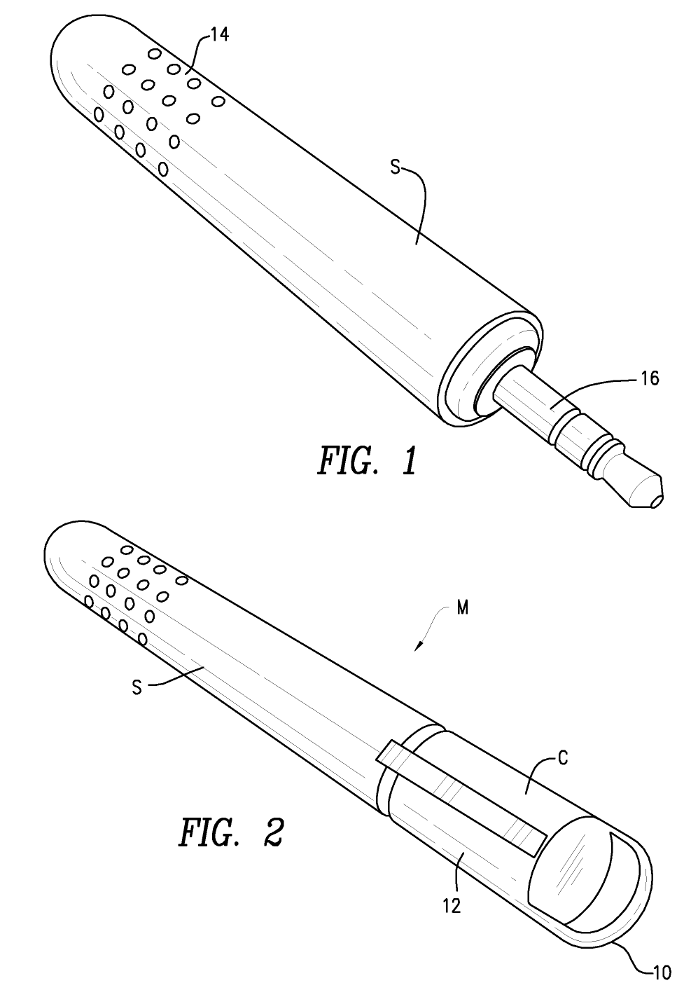

Turning now to the drawings, FIGS. 1 and 2 are perspective views illustrating a transportable miniature microphone assembly M embodying the present invention. The assembly M broadly comprises a sensor portion S and a cap portion C, which connects detachably to the sensor portion S, preferably by a snap-fitting.

The cap portion C includes an integral loop 10, which permits the assembly M to be fitted to a mounting ring, for example on a key chain, or the like. Similarly, the assembly M may be mounted to a belt or a belt loop, an article of clothing, or another apparatus. Ultimately, or in addition, cover C may be provided with a pocket clip 12 of the type commonly found on pens and mechanical pencils. As a further alternative, clip 12 could be replaced by a strip of hook-and-pile securing material of the type available under the trademark Velcro, in which case assembly M may be secured to any surface that has a mating hook-and-pile element.

Preferably, the exterior of the sensor S and cover C are made of a plastic material, although they may also be metal. At a forward end, sensor S includes a plurality of perforations 14, which permit sound to enter and be received by an internal microphone. At a rear end, sensor S includes an industry standard, miniature stereo plug 16, of the type typically found on portable computing devices, such as PDA's. Within sensor S plug 16 is electrically connected to the internal microphone.

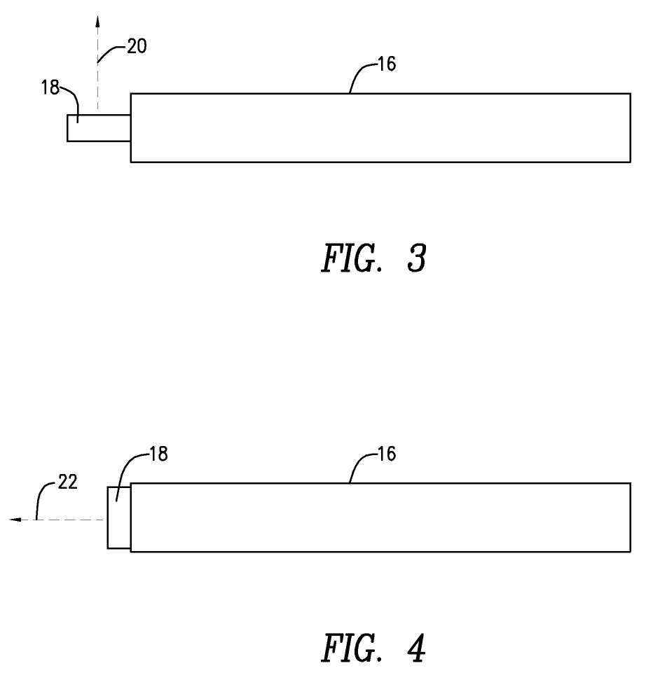

FIGS. 3 and 4 are schematic diagrams illustrating the internal construction of alternative versions of sensor S. In FIG. 3, a microphone 18 is electrically connected to the stereo plug 16 and is mounted so that it receives sound primarily in a vertical direction, as indicated by the arrow 20. Alternatively, as shown by the arrow 22 in FIG. 4, the microphone maybe mounted so as to receive sound in a horizontal direction. It is also contemplated that a microphone may be used which is multi-directional, receiving sound essentially uniformly from all directions.

It will be appreciated that when a directional microphone is utilized as illustrated in FIG. 3, after plug 16 is inserted in a computing device, it will be possible to rotate sensor S axially in order to change the receiving direction of microphone 18.

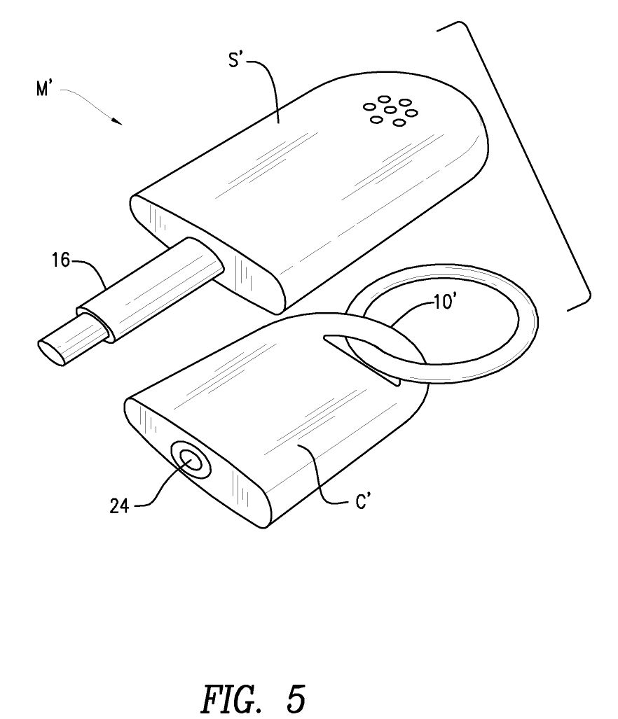

FIG. 5 is a perspective view of a further embodiment M′ of a transportable sensor in accordance with the present invention. The sensor M′ broadly comprises a sensor portion S′ and a cover portion C′. Sensor M′ includes an opening 24 in cover C′ in which the stereo plug 16 of sensor portion S′ is received with a snap fit. Sensor M′ is therefore easily assembled and disassembled by pressing together or pulling apart the components S′ and C′. Cover C′ includes a ring portion 10′ to permit sensor M′ to be attached to a person or article. As was the case in FIG. 2, in place of, or in addition to, ring 10′ a clip 12 may be provided or a component of a loop-and-pile fastener.

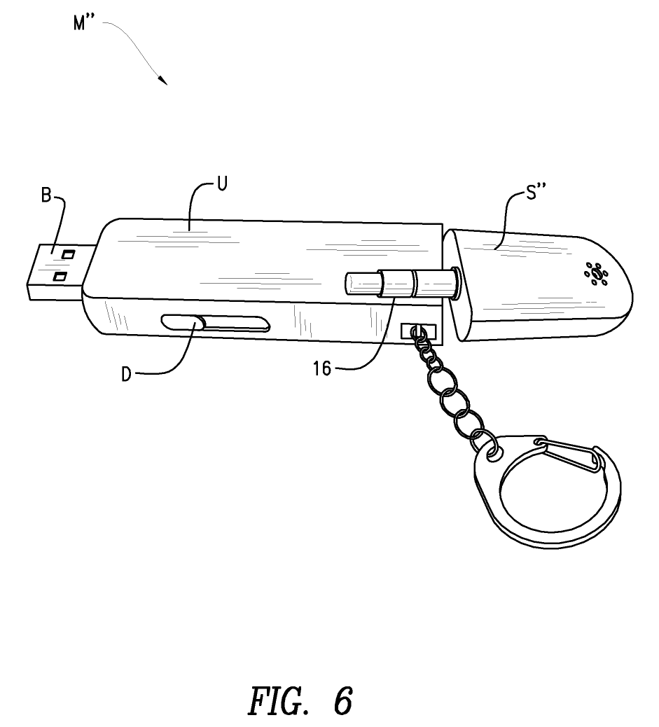

FIG. 6 is a perspective view of yet another embodiment M″ of a sensor embodying the present invention. In this case, a sensor S″ is mounted in an industry standard, USB memory storage unit U. The mounting is preferable the same as illustrative in FIG. 5. As is known, the unit U includes a USB connector B which may be extended or withdrawn into the unit U by operating a slide switch D.

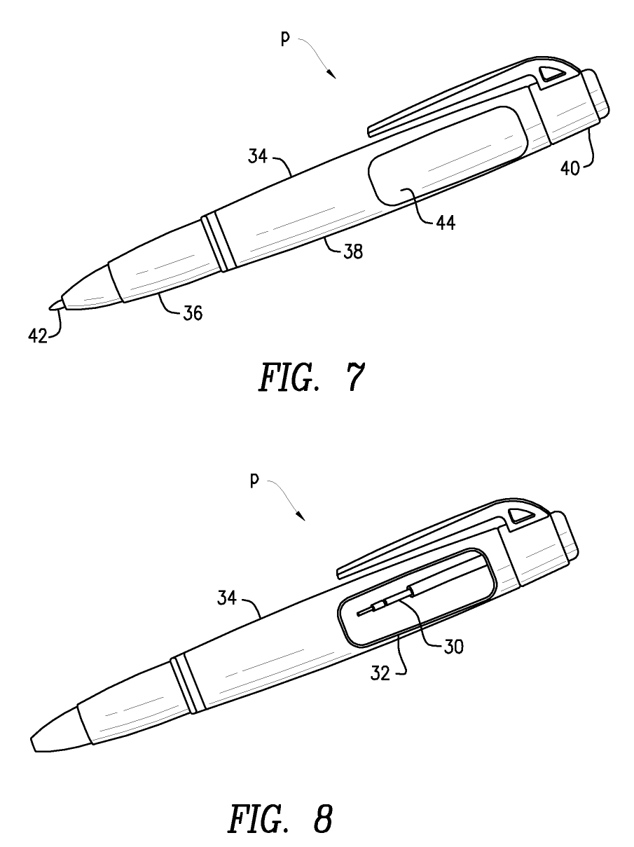

FIGS. 7 and 8 are perspective views of yet another embodiment P of a transportable sensor embodying the present invention. In embodiment P, a sensor 30 is mounted within a compartment 32 in the body of a pen 34. Pens of this type are commercially available. They include coaxial portions 36, 38 and 40, which are mounted for relative rotation about their axis. Relative rotation between portions 36 and 38 causes a pen point 42 to be extended or retraced, and relative rotation between portions 38 and 40 causes a cover 42 for compartment 32 to be moved into a closed position (FIG. 7) or an open position (FIG. 8). Accordingly, a user who carries the pen P will always have the sensor 30 available and may access it quickly and easily through relative rotation of portions 38 and 40.

Although preferred embodiments of the invention have been disclosed for illustrative purposes, those skilled in the art will appreciate that many additions, modification, and substitutions are possible without departing from the scope and spirit of the invention as defined by the accompanying claims.

1. A transportable sensor comprising a sensing element producing an electrical signal in response to an external condition, the sensor being constructed to fit an electrical communication connection on a computing device and to communicate the electrical signal therethrough to the computing device, and having a separate mechanical connection.

2. The sensor of claim 1, wherein the sensor is formed in first and second parts, the first part including the sensing element and the communication connection, and the second part including the mechanical connection and a mating connection for detachably receiving the communication connection, whereby the first and second parts are conveniently separated to permit use of the first part with a computing device.

3. The sensor of claim 2 wherein said mechanical connection is constructed to detachably attach to one of an article worn by or an article carried by a user of the sensor.

4. The sensor of claim 3, wherein the mechanical connection is one of a loop element and a detachable clip.

5. The sensor of claim 1 wherein said mechanical connection is constructed to detachably attach to one of an article worn by or an article carried by a user of the sensor.

6. The sensor of claim 5, wherein the mechanical connection is one of a loop element and a detachable clip.

7. The sensor of claim 6, wherein the mechanical connection is a garment pocket clip.

8. The sensor of claim 1 wherein said communication connection is an industry standard connection.

9. The sensor of claim 1 wherein said sensing element is a miniature microphone.

10. The sensor of claim 9 wherein said communication connection permits the sensor to be rotated about an axis, the microphone being directionally sensitive in a direction generally perpendicular to the axis and being mounted to rotate with the sensor about said axis.

11. The sensor of claim 1, wherein the sensor is formed in first and second parts, the first part including the sensing element and the communication connection, and the second part comprising a separate device useable with a computing device and a mating connection for detachably receiving the communication connection, whereby the first and second parts are conveniently separated to permit separate use of the first and second parts with a computing device.

12. The sensor of claim 1, wherein the second part comprises a USB memory device.

13. In combination, a sensor comprising a sensing element producing an electrical signal in response to an external condition, the sensor being constructed to fit an electrical communication connection on a computing device and to communicate the electrical signal therethrough to the computing device, and an article having separate utility from the sensor, the article having a compartment constructed to removably receive the sensor, the article being constructed to be one of transportable and worn by a user of the sensor.

14. The combination of claim 13 further comprising a closed cover on said compartment openable by the user to access, remove and replace the sensor.

15. The sensor of claim 13 wherein said communication connection is an industry standard connection.

16. The sensor of claim 13 wherein said sensing element is a miniature microphone.

17. The sensor of claim 16 wherein said communication connection permits the sensor to be rotated about an axis, the microphone being directionally sensitive in a direction generally perpendicular to the axis and being mounted to rotate with the sensor about said axis.

18. The combination of claim 13 wherein the article is a pen.

19. The combination of claim 18 further comprising a closed cover on said compartment openable by the user to access, remove and replace the sensor.
